(19) United States
(12) Patent Application Publication
(10) Pub. No.: US 2025/0128398 A1
(43) Pub. Date: Apr. 24, 2025

(54) PORTABLE WORK TABLE, MACHINING ARRANGEMENT AND METHOD

(71) Applicant: Festool GmbH, Wendlingen (DE)

(72) Inventor: Timo BAYER, Tübingen (DE)

(21) Appl. No.: 18/834,447

(22) PCT Filed: Feb. 2, 2023
(86) PCT No.: PCT/EP2023/052555

§ 371 Date: Jul. 30, 2024

(30) Foreign Application Priority Data
Feb. 4, 2022 (DE) 10 2022 201 210.0

(51) Int. Cl. B25H 1/04; B23D 47/02; B62B 1/12

(52) U.S. Cl. CPC B25H 1/04; B23D 47/025; B62B 1/12; B62B 2202/48

(57) ABSTRACT

A portable worktable having a support structure with a table operating assembly, in which the portable worktable can be positioned on a stand surface, and a support, which extends along a longitudinal direction and a width direction. The support includes a first support and the support structure can be moved into a first working configuration for using the portable worktable as a table and a second working configuration for using the portable worktable as an underlying surface at a height near the floor. The portable worktable can be moved into a transport configuration in which the portable worktable can be manually moved into a tilting position and can be moved relative to the stand surface. The portable worktable has a second support, which can be moved into a first support position, in particular a workpiece support position, or a second support position, in particular a workpiece stabilizing position.

The invention relates to a portable work table, comprising a carrier structure with a table leg arrangement with which the portable work table can be placed on a stand surface, and a rest which extends along a longitudinal direction and a width direction, wherein the rest comprises a first rest which is fixed, in particular fastened to the carrier structure.

The carrier structure can be brought into a first working configuration for the use of the portable work table as a table. Optionally, the carrier structure can be brought into a second working configuration for the use of the portable work table as a base surface at a height close to the ground.

The portable work table can be brought into a transport configuration in which the portable work table can be manually brought into a tilt position and be moved, in particular displaced, relative to the ground, for the transport of the portable work table, in particular together with a semi-stationary electrical tool and/or a transport box.

EP2845694B1 discloses a portable workbench with limbs for supporting a body, two wheels which are connected to the body and a grip which is connected to the body, wherein the portable workbench can be brought into a transport position.

WO2019228645A1 discloses a transport device with a placement surface for receiving and coupling a box-like container by way of a container fastening interface, two wheels which are arranged in a rearward region of the transport vehicle and a frame on which a table top can be supported.

U.S. Pat. No. 8,602,378B2 discloses a sub-frame for a semi-stationary saw which can be brought into a transport position and a working position.

An object of the invention lies in providing a portable work table which can be used in a versatile manner and a machining unit comprising such a portable work table.

The object is achieved by a portable work table according to claim 1. The portable work table comprises a second rest which can be selectively brought into a first rest position, in particular into a workpiece rest position, or into a second rest position, in particular a workpiece support position.

The carrier structure can be brought by a user into the first working configuration and the second rest into the first rest position, in order to provide a work table with a flat or plane rest surface, for example as a mobile workbench at a building site, for machining in particular long workpieces.

Furthermore, the portable work table can be brought by the user into a first working configuration and the second rest into the second rest position, in order to provide a sub-frame for a semi-stationary electric tool, for example a mobile bench saw. Semi-stationary electrical tools are very compact due to the demands of a simple transportability, which greatly limits the dimensions of the workpiece rest. The second rest of the portable work table therefore represents a lengthened workpiece rest or additional support for a workpiece which is to be machined with the semi-stationary electrical tool.

Furthermore, the portable work table can be brought by the user into a transport configuration for the transport of the portable work table, in particular together with the semi-stationary electrical tool and/or the transport box. In the transport configuration, the first rest is aligned essentially perpendicularly to the second rest and the portable work table is supported at least partly by the wheels. In this manner, the transport box, for example for a semi-stationary electrical tool can be vertically supported by the second rest on transport with the portable work table.

The portable work table can be brought by the user into the transport configuration by way of the table leg arrangement being received in a table leg receiving volume below the rest, in particular in a complete manner, so that the table leg arrangement is of no hindrance to the user on transport, the second rest being brought into the second rest position, so that the transport box can be supported by this, and the portable work table being brought into an essentially vertical position. Consequently, only a few hand manipulations are necessary in order to bring the portable work table together with the semi-stationary electrical tool and/or the transport box into a state which is ready for transport.

This is particularly the case if the portable work table comprises wheels and/or a handle which are arranged on the carrier structure.

Advantageously, the handle in the longitudinal direction is arranged on the one side of the carrier structure and/or of the rest, and the wheels in the longitudinal direction are arranged on the other side of the carrier structure and/or of the rest, so that the portable work table can be manually brought into the tilt position via the grip and be moved or displaced relative to the stand surface, in particular on the stand surface, by way of wheels.

Furthermore, the portable work table can be brought manually into a second working configuration. Advantageously, the carrier structure comprises a stand foot arrangement, so that the work table is supported on the stand surface at least partly by the stand foot arrangement, and the rest, in particular the first rest can be aligned parallel to the stand surface, in particular at a height close to the ground. In this manner, large and heavy workpieces can be simply machined on the portable work table.

Advantageous further developments are the subject-matter of the dependent claims.

The invention further relates to a machining unit comprising the portable work table and the semi-stationary electrical tool.

The invention further relates to a method for operating the portable wok table or the machining unit, comprising the step: bringing the second rest into a first rest position or a second rest position.

Further exemplary details as well as exemplary embodiments are hereinafter explained with reference to the figures. Herein, the are shown

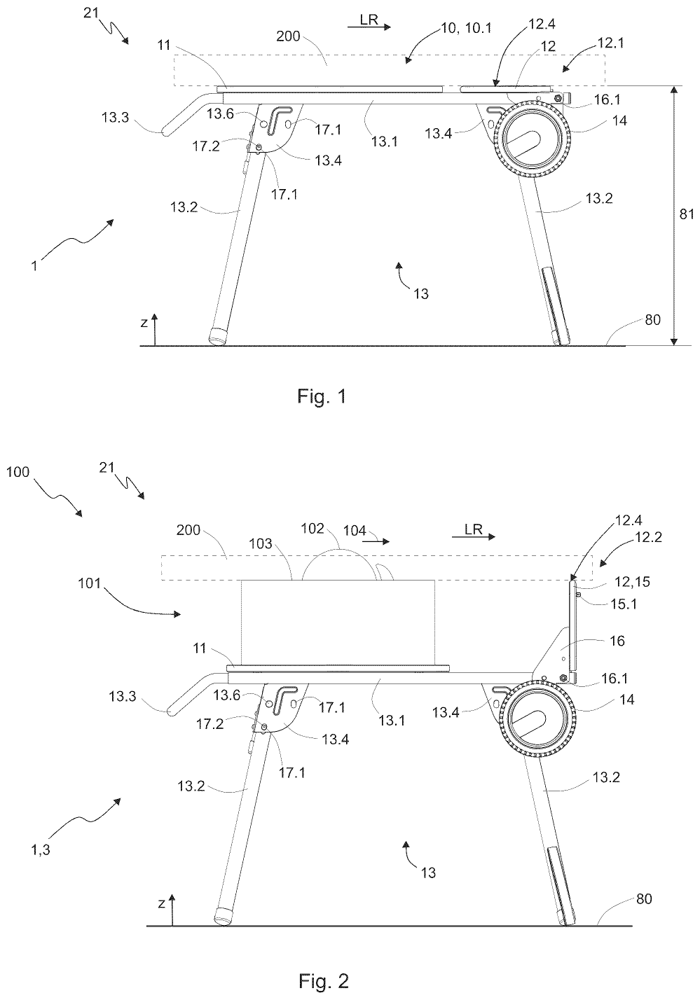

FIG. 1 a portable work table in a lateral view,

FIG. 2 a machining unit in a lateral view according to a first embodiment,

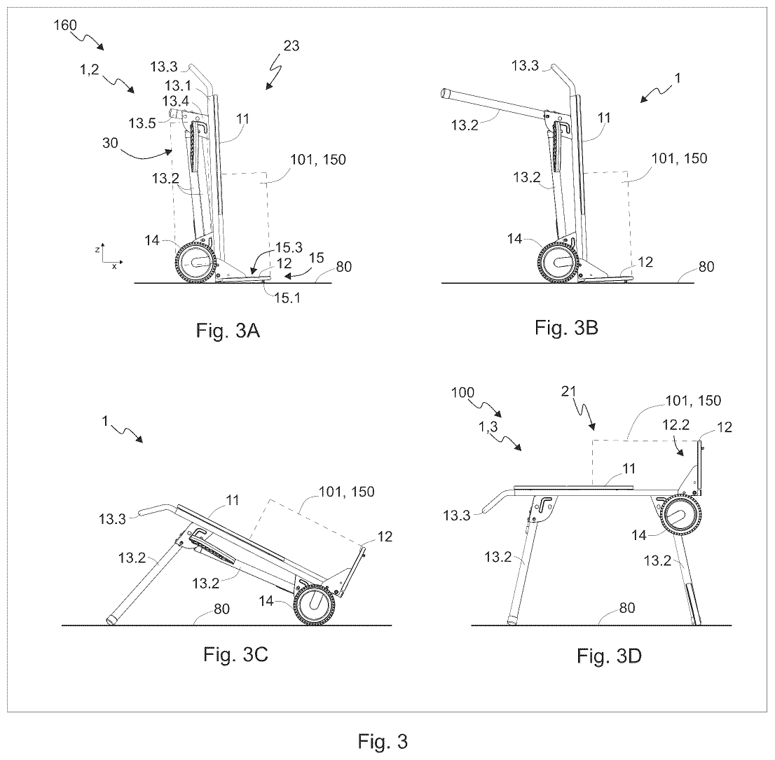

FIG. 3A a portable work table in the transport configuration,

FIG. 3B a first step for the transformation of a transport configuration into a working configuration,

FIG. 3C a second step for the transformation from a transport configuration into a working configuration,

FIG. 3D a portable work table in the first working configuration,

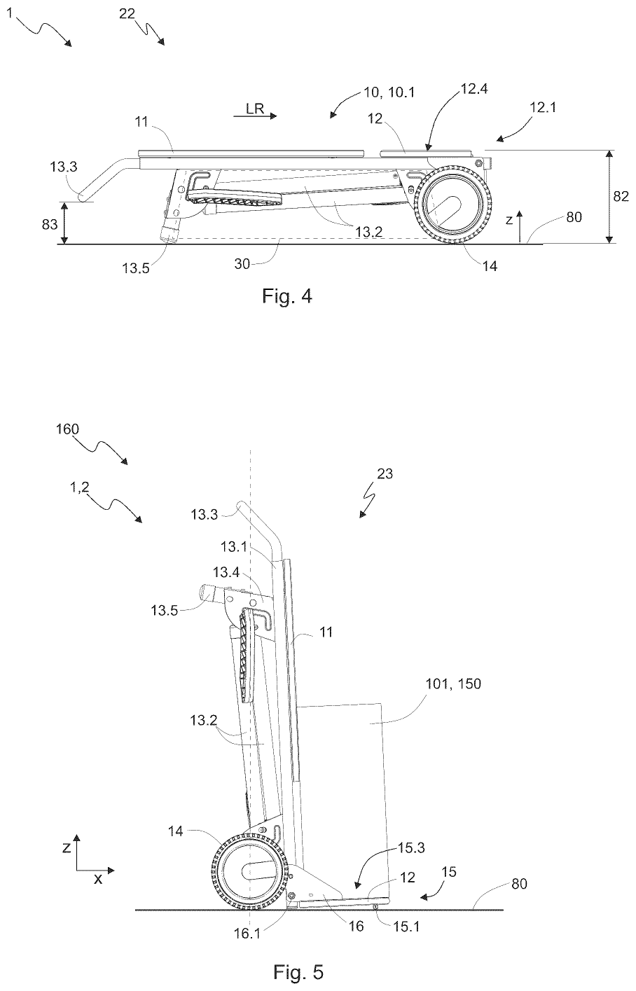

FIG. 4 a portable work table in a second working configuration, in a lateral view,

FIG. 5 a portable work table which is designed as a sack barrow in the transport configuration, in a lateral view

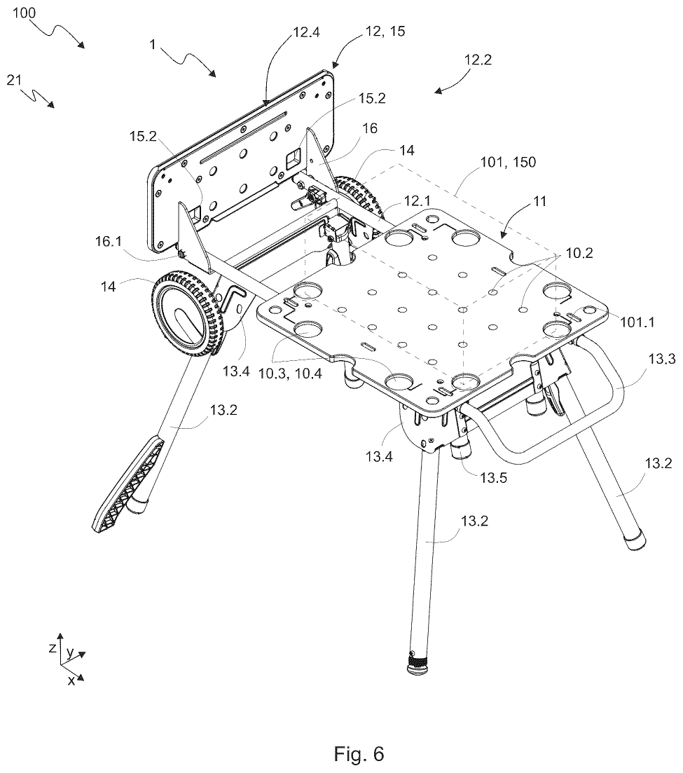

FIG. 6 a portable work table in a first working configuration, in an oblique view,

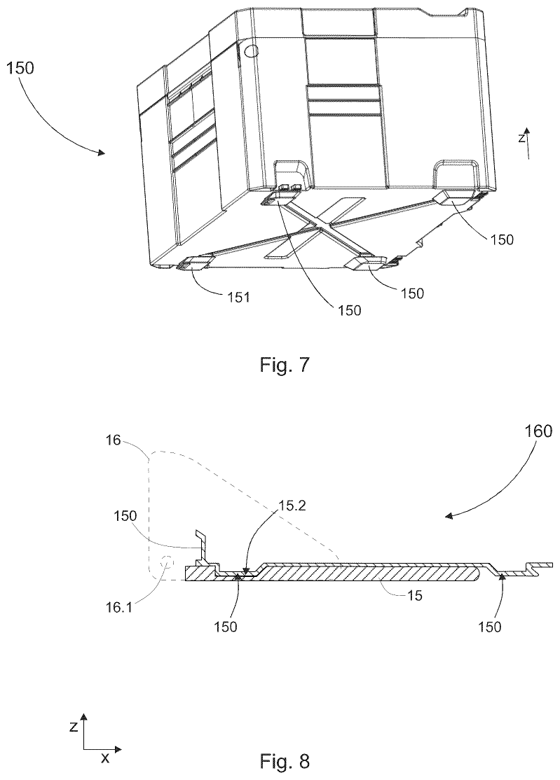

FIG. 7 a transport box,

FIG. 8 a section through a coupling receiver of the second rest,

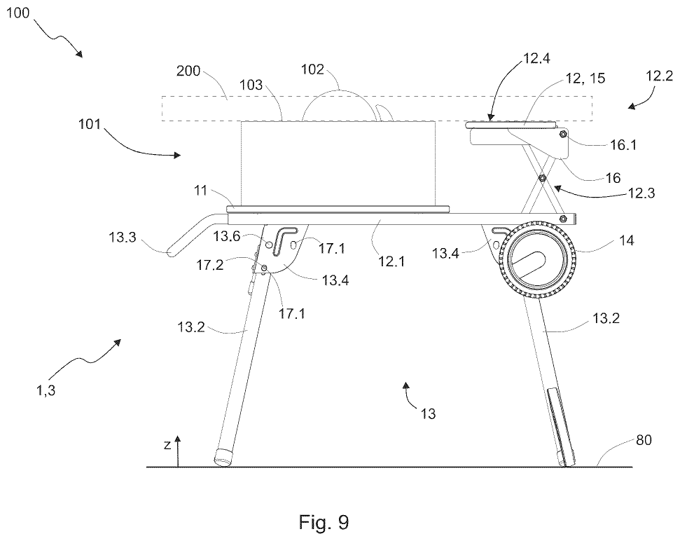

FIG. 9 a machining unit in a lateral view according to a further embodiment,

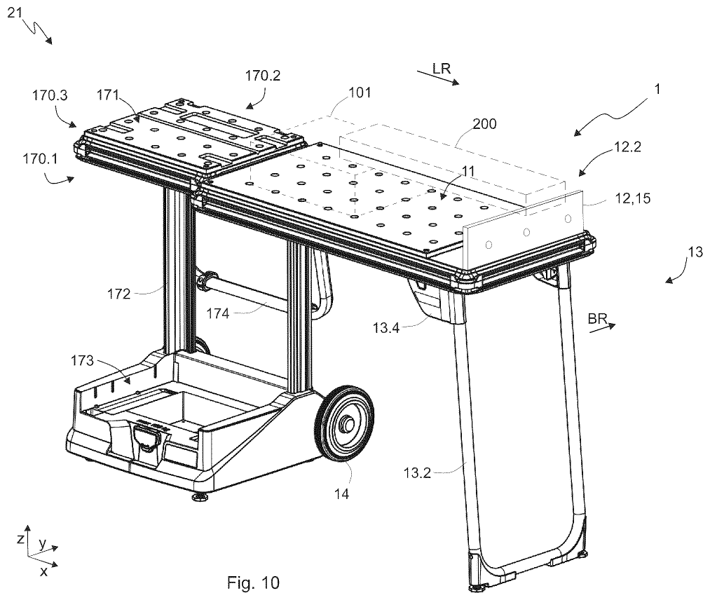

FIG. 10 a portable work table according to a third embodiment.

FIG. 1 shows an exemplary design of the portable work table 1. The portable work table comprises a rest 10 and a carrier structure 13. The rest 10 comprises a first rest 11 and a second rest 12.

The x-direction, y-direction and z-direction which are drawn in the figures are to be referred to in the following explanation. The x-direction and the y-direction are horizontal directions and are aligned orthogonally to one another. By way of example, the x-direction is aligned in the direction of a displacement direction in which a portable work table can be displaced. The y-direction by way of example is aligned orthogonally to the displacement direction. The z-direction by way of example is a vertical direction and is aligned orthogonally to the x-direction and y-direction.

The rest 10 is arranged on the carrier structure 13. By way of example, the first rest 11 in particular is placed on the carrier structure and/or is fixed on this. Advantageously, the second rest 12 is movably mounted on the carrier structure 13 and herewith can be brought at least into a first rest position 12.1 and into a second rest position 12.1. In the represented embodiment, the second rest is situated in the first rest position 12.1 in order together with the first rest 11 to form an in particular plane rest surface 10.1, on which for example a workpiece 200 can be placed and/or machined.

By way of example, the second rest is mounted on the carrier structure 13 via a rotary joint, so that the second rest 12 by way of a rotation about a rotation axis 16.1 which is arranged parallel to the rest surface 10.1 can be brought from the first rest position 12.1 into the second rest position 12.1 or from the second rest position 12.2 into the first rest position 12.1.

The carrier structure 13 comprises a rest carrier 13.1 as well as a table leg arrangement 13.2 which by way of table leg receivers 13.4 is held on the rest carrier 13.1 and with which the carrier structure 13 can be placed on a stand surface 80. By way of example, one envisages the table leg arrangement 13.2 being pivotably arranged on the rest carrier 13.1 by way of table leg joints 13.6. The table leg arrangement 13.2 is expediently secured in the respective end position by way of a locking 17. The locking 17 by way of example can comprise a manually actuatable latch element 17.2 and a latch receiver 17.1 which in the secured state at least partly receives the latch element 17.2. Expediently, the latch element 17.2 which is designed for example as a pin is arranged on the table leg arrangement 13.2, and the latch receiver 17.1, for example designed as a hole, is arranged on the table leg receiver 13.4, wherein the latch receiver 17.1 preferably comprises at least two latching positions. The one latching position forms a first end position latching position for locking the table leg arrangement 13.2 corresponding to a first working configuration 21 and the other latching position forms a second end position latching position for locking the table leg arrangement 13.2 corresponding to a second working configuration 22.

By way of example, the table leg arrangement 13.2 in FIG. 1 comprises four table legs each with a locking 17, so that the table legs can be individually brought by the user from one end position into the other end position. Alternatively, it is also conceivable for two table legs, as is shown in FIG. 10, to form a table leg unit, so that the table legs can be brought by the user in pairs from one end position into the other end position.

Alternatively, it is also conceivable for the table leg arrangement 13.2 and the table leg receivers 13.4 to be connected to one another by way of a plug-in connection.

The portable work table 1, in particular the carrier structure 13 is represented in the first working configuration 21 in FIG. 1. In the first working configuration 21, the table leg arrangement 13.2, in particular the table legs are situated in the first end position, in particular the first end position latching position, so that the carrier structure 13 can be placed on the stand surface 80 by way of the table leg arrangement 13.2 Expediently, in the first working configuration 21, the rest 10 of the portable work table has a working height or rest height 81 which is comfortable for the user. The first rest height 81 is herein the maximal distance between the rest surface 10.1 and the table leg arrangement 13.2, in particular in a z-direction. Expressed differently, the first rest height 81 is the height of the rest surface 101 above the stand surface 80 when the portable work table 1 is situated in the first working configuration 21. By way of example, the rest height 81 is equal to 80 centimetres. At the first working height 81 of the rest 10, a standing user can contact the rest 10 with both hands.

Furthermore, the carrier structure 13 can comprise a handle 13.3 which is fixed for example on the rest carrier 13.1.

By way of example, wheels 14 are rotatably mounted on the carrier structure 13. In the first working configuration 21, the portable work table 1 preferably cannot be placed with the wheels 14 on the stand surface 80, in particular the wheels 14 are distanced to the stand surface 80 in the first working configuration 21.

A further variant according to the invention envisages arranging, in particular placing a semi-stationary electrical tool 101 on the rest 10, in particular on the first rest 11, in order to form a machining unit 100. In other words, the machining unit 100 comprises the portable work table 1 and the semi-stationary electrical tool 101 which is designed as mobile bench saw.

The electrical tool 101 comprises at least one workpiece rest 103 and a saw blade 102 which is arranged in a cutting plane and is for the cutting machining of a workpiece 200 which can be placed on the workpiece rest 103.

FIG. 2 shows the portable work table in the first working configuration 21 and the second rest 12 in the second rest position 12.2. The second rest 12 therefore forms a workpiece support, in order to additionally support a workpiece 200 which is placed onto the workpiece rest 103, in a manner distanced to the workpiece rest 103.

A variant according to the invention envisages the second rest 12.2 of the machining unit 100 being arranged behind the semi-stationary electrical tool 101 in the feed direction 104 of the workpiece 200 which is to be machined with the electrical tool. This can be useful if long and/or narrow workpieces are to be machined with the electrical tool.

An alternative variant envisages the second rest 12.2 of the machining unit 100 being arranged next to the semi-stationary electrical a tool 101 in the feed direction 104 of the workpiece 200 which is to be machined with the electrical tool. In particular, this is advantageous if wide workpieces are to be machined with the electrical tool.

An advantageous embodiment of the machining unit envisages the second rest 12 comprising or forming a side 12.4 which is away from the carrier structure 13 in the second rest position. The distant side 12.4 is designed to form a workpiece support, in particular an additional workpiece support or one which is distanced to the workpiece rest 103, for a workpiece 200 which can be machined with the electrical tool. The second rest position 12.2 of the second rest can therefore also be denoted as a workpiece support position.

Advantageously, the workpiece rest 103 and the second rest 12 are arranged to one another such that the side 12.4 which is away from the support structure does not project beyond the workpiece rest 103 in the z-direction and/or that the workpiece rest 103 does not project beyond the side 12.4 which is away from the carrier structure by more than 10 millimetres, preferably by not more than 5 millimetres in the z-direction. Particular preferably, the workpiece rest 103 and the second rest 12 are arranged to one another such that the side 12.4 which is away from the carrier structure has the same distance to the rest surface which is formed by the first rest 11. A plane workpiece 200, in particular a plate or beam, which is applied onto the workpiece rest 103 in a two-dimensional manner can thus likewise (in particular simultaneously) be supported by the second rest 12, in particular by the side 12.4 which is away from the carrier structure. In particular, the upper edge (by way of example formed by the side 12.4) of the second rest 12 which is situated in the second rest position 12.2 is located at the same height as the workpiece rest.

FIG. 9 shows a second rest 12 according to a further embodiment. In this embodiment, the second rest 12 further comprises a height adjustment, by way of example in the form of a scissor mechanism, for setting a height of the second rest 12 relative to the first rest 11. By way of this, a wider support surface for supporting a workpiece 200 which is machined with the semi-stationary electrical tool 101 is created. An adaptation of the support height to different semi-stationary tools is also possible.

In FIG. 9, the second rest 12 cannot be brought from the first rest position 12.1 into the second rest position 12.2 by way of a rotary joint arrangement.

In FIG. 4, the portable work table 1, in particular the carrier structure 12 is represented in the second working configuration 22. In the second working configuration 22, the table leg arrangement 13.2, in particular the table legs are situated in the second end position, in particular the second end position latching position, so that the table leg arrangement 13.2 is received in a table leg receiving volume 30. The portable work table 1 therefore cannot be placed with the table leg arrangement 13.2 on the stand surface 80.

Expediently, the carrier structure 13 is such that the carrier structure 13 forms stand points which are parallel to the rest 10. Hence the rest 10 can be aligned parallel to the placement plane 80 in the second working position 22.

Advantageously, the carrier structure 13 comprises a support foot arrangement 13.5, with which in the second working configuration 22 the carrier structure 13 can be at least partly placed on the stand surface 80, in particular can be placed such that a working height or second rest height 82 of the rest 10 is less than the first rest height 81, in particular by less than 40 centimetres.

It is particular advantageous if the handle 13.3 is distanced to the stand surface 80 in the second working position 22. A handle ground distance 83 between the stand surface 80 and the lower edge of the handle 13.3 is therefore greater than zero. It is further advantageous if the handle 13.3 is arranged below the rest 10, in particular below the rest surface 10.1, in the z-direction.

A transport configuration 23 of the portable work table 10 is represented in FIG. 5. In the transport configuration 23, the second rest 12 is aligned essentially perpendicularly to the first rest 11 and the portable work table 1 can be at least partly supported by the wheels or displaced by the wheels. Herewith, the portable work table in the transport configuration 23 is designed as a sack barrow 2 with a ledge 15 which is formed by the second rest 12.

The sack barrow 2 can be placed in an upright or upwardly placed position which extends essentially in the z-direction. This can also be denoted as the parking position. In the parking position, the ledge 15 is aligned essentially in an xy-plane.

Expediently, the ledge 15 comprises a placement surface 15.3 and/or support elements 15.1. The support elements 15.1 are arranged on the lower side of the ledge and from the lower side point in the negative z-direction. Expediently, the ledge 15 can be supported on the stand surface 80 by way of the support elements 15.1. Herewith, in the parking position the sack barrow 2 can be supported on the stand surface 80 by the support elements 15.1 and the wheels 14.

Preferably, the support elements 15.1 are arranged on the ledge 15 in a lowerable or pivotable manner such that in the transport configuration 23 these protrude from the lower side of the ledge 15 or project beyond the lower side of the ledge 15 in the negative z-direction and in the first or second working configuration 21, 22 do not project beyond the lower side of the ledge 15 in the negative z-direction.

The placement surface 15.3 is arranged on the upper side of the ledge and is orientated essentially perpendicularly to the z-direction in the parking position. Hence the placement surface 15.3 can be used in order to receive transport boxes.

Such a transport box 150 which is designed as a box-like container is represented by way of example in FIG. 7. As a rule, tools, for example an electrical tool and/or tool accessories are kept in the transport box 150. In particular, the transport boxes 150 are designed in a manner such that they can be stacked upon one another and be coupled to one another in a vertically tensionally rigid manner, in order to form a stable vertical, in particular cuboid stack. For this purpose, the transport boxes 150 each have the same horizontal outline as well as a coupling interface comprising coupling means 151 and coupling receivers with which they can be coupled to one another. The stack or an individual transport box can be placed with the lowermost box-like container on the placement surface 15.3 of the sack barrow 2. The combination of the portable work table 1 which is designed as a sack barrow 2 and of the transport box 150 can also be denoted as a transport unit 150.

The coupling means 151 which by way of example are arranged on the lower side of the transport box 150 are represented in FIG. 7. By way of example, the coupling means 151 are designed as protrusions which project out of the base surface of the transport box 150 in the negative z-direction.

Advantageously, the placement surface 15.3 of the transport unit 160 comprises coupling receivers 15.2 which in particular are designed as recesses, for receiving coupling means. FIG. 8 shows a sectioned representation perpendicular to the placement surface 15.3 through the ledge 15 and the transport box 150 of the transport unit 160. In the shown embodiment example, the rear (lying to the rear in the x-direction) coupling means 151 of the transport box 150 engage into coupling receivers 15.2 of the ledge 15. In this manner, a slipping of the transport box 50 on the ledge 15 is avoided. Alternatively or additionally, one can envisage the ledge 15 being laterally delimited by plates 16, as is represented by way of example in FIG. 5. Herewith, a slippage of the transport box 150 on the ledge 15 is likewise avoided.

Expediently, the y-distance between the plates 16 corresponds to a width of the transport box 150.

In the transport configuration 23, the portable work table 1 can be brought manually into a tilt position, concerning which the portable work table 1 is tilted with respect to the ground about a tilt axis which is defined by the wheels. In this state, the portable work table 1 can be moved, in particular pushed or pulled in the manner of a sack barrow.

FIG. 3 shows an example for the conversion of the portable work table 1 from a transport configuration 23 (FIG. 3A) into the first working configuration (FIG. 3D), wherein intermediate steps of the conversion are shown in the FIGS. 3B and 3C. If the transport box 150 contains the semi-stationary electric tool 101, as is shown in FIG. 3 in a dashed manner, then FIG. 3 clarifies the conversion of the portable work table 1 from the transport unit 160 into the working unit 100.

FIG. 3A shows the portable work table 1 in a transport configuration 23 with a table leg arrangement 13.2 which is received in the table leg receiving volume 30. The table leg arrangement 13.2 comprises a pair of grip-side table legs and a pair of wheel-side table legs, and these in the transport configuration can also be denoted as upper and lower table legs. By way of example, the transport box 150, for example for the transport of a semi-stationary electric tool 101 can be received by the placement surface 15.2 of the ledge 15, in order to form the transport vehicle 160. The transport unit 160 can be supported on the stand surface 80 in an upright position via the wheels 14 and the support elements 15.2. In FIG. 3A the transport unit 160 is represented in the parking position.

The transport unit 160 can now be converted into a machining unit 100 in a simple manner by way of the following steps:
bringing the upper table leg arrangement 13.2 into a stand-up position, for example by way of releasing the locking in the second end position, folding out the upper table leg arrangement 13.2, locking the upper table leg arrangement 13.2 in the first end position;
bringing the portable work table 1 into a tilt position, concerning which the portable work table 1 is tilted with respect to the ground about a tilt axis which is defined by the wheels, in order to support the portable work table 1 with the upper table leg arrangement 13.2 and the wheels 14 on the stand surface 80 in the tilt position;
lifting the ledge-side or wheel-side side of the portable work table 1;
bringing the wheel-side table leg arrangement 13.2 into a standing position, for example by way of releasing the locking in the second end position, folding out the lower table leg arrangement 13.2, locking the lower table leg arrangement 13.2 in the first end position; and
arranging the semi-stationary electric tool 101 on the first rest 11, in order to arrange the workpiece rest 103 in a manner distanced to the ledge 15, in particular to the distant side 12.4 of the ledge. In order to arrange the semi-stationary electric tool 101 on the first rest 11, it can be necessary to release the transport box 150 which receives the electric tool, with its coupling means 151 from the coupling receivers 15.2, to bring the electrical tool from a transport position close to the ledge in the direction of the first rest 11 and optionally to release a (not represented) protective hood of the electric tool.

Advantageously, the semi-stationary electric tool 101 comprises tool feet 101.1 in order to place or support the electric tool 101 on the rest 10. The semi-stationary electric tool 101 and the tool feet 101 are indicated in FIG. 6 in a dashed manner.

Advantageously, the rest 10 on the side of the rest 10, in particular of the first rest 11, said side being way from the support structure 13, comprises a hole structure, in particular of through-holes 10.2 and/or blind holes 10.3 and/or recesses 10.4. The hole structure, in particular the blind holes 10.3 and/or recesses 10.4 are designed to form a positive fit with the tool feet 101.1 in the direction of the rest plane of the first rest 11. In this manner, the semi-stationary electric tool is fixed relative to the first rest in the xy-plane. The hole structure, in particular the blind holes 10.3 and/or recesses 10.4 are hence designed to form a coupling interface for the semi-stationary electric tool 101.

Preferably, a portable work table 1 is provided. A portable work table is expediently a table which can be carried by an individual person. The portable work table 1 comprises a carrier structure 13 which includes a rest carrier 13.1 and a table leg arrangement 13.2 which is pivotably attached to the rest carrier 3.1. Furthermore, a first rest 11 and a second rest 12 which are each expediently designed in a plate-like manner are attached to the rest carrier 13.1. The second rest 12 is expediently attached to the rest carrier 13.1 in a pivotable manner. Preferably, the portable work table 1 comprises two wheels 14 which are arranged on the support structure 13.

The portable work table 1 can be selectively brought into a transport configuration or into a first working configuration.

In the transport configuration, the portable work table 1 represents a sack barrow. In the transport configuration, the table leg arrangement 13.2 is pivoted onto the rest carrier 13.1. In the transport configuration, the portable work table 1 (in particular in a tilt position) is supported with respect to a base surface, for example the ground, and can be displaced relative to the base surface with the wheels 14. By way of example, the base surface is the stand surface 80. In the transport configuration, the second rest 12 is pivoted with respect to the first rest 11 such that it is aligned with its rest plane perpendicular to the rest plane of the first rest 11. In the transport configuration, the second rest 12 forms a ledge of the (formed by the work table 1) sack barrow. In a vertical alignment in the transport configuration, the portable work table 1 stands on the lower side of the second rest 12 and/or the rest carrier 13.1 and/or the first rest 11 is aligned vertically.

In the first working configuration 21, the portable work table 1 represents a table. The table leg arrangement 13.2 is pivoted away from the rest carrier 13.1. The rest carrier 13.1 and/or the first rest 11 are aligned horizontally. The table leg arrangement 13.2 projects downwards from the rest carrier 13.1. The portable work table is supported with the table leg arrangement 13.2 (and in particular not with the wheels 14) with respect to a base surface, for example the ground. The second rest 12 is expediently aligned horizontally with its rest plane. In particular, the rest plane of the first rest 11 and the rest plane of the second rest 12 lie in a common (imagined) plane and are expediently located at the same height with respect to the base surface.

Preferably, a machining unit 100 is provided, said machining unit comprising the portable table 1 in the first working configuration and an electrical tool 101, for example bench saw, which is placed onto the first rest 11.

The second rest 12 can be selectively brought into a first rest position 12.1, in particular workpiece rest position, or into a second rest position 12.2, in particular a workpiece support position, in particular by way of pivoting the second rest 12 relative to the first rest 11. In particular, the second rest 12 in the first working configuration 21 can be brought from the first rest position 12.1 into the second rest position 12.2 and/or from the second rest position 12.2 into the first rest position 12.1, in particular without changing and/or moving the first rest 11. The second rest 12 by way of example is mounted on the rest carrier 13.1 in a distanced manner and/or independently of the first rest 11, so that the second rest 12 can be selectively brought into the first rest position and the second rest position, whilst the first rest 11 remains unchanged.

The first rest position 12.1, thus the workpiece rest position is shown in FIG. 1. In the workpiece rest position of the second rest 12, the rest planes of the first rest 11 and of the second rest 12 lie in a common (in particular horizontal) plane and thus together provide an (in particular horizontal) rest surface 10.1 for a workpiece 200.

The second rest position 12.2, thus the workpiece support position is shown in FIG. 2. In the workpiece support position, the second rest 12 is pivoted by 90 degrees with respect to the workpiece rest position. The side 12.4 which is away from the carrier structure in the workpiece support position is also to be denoted as a support side of the second rest 12. This support side in the workpiece support position expediently represents the highest region (in particular the highest point and/or the highest surface) of the second rest 12 and/or in the workpiece support position is higher than the rest plane of the first rest 11.

In a state, in which the electric tool 101 stands (with its lower side) on the first rest 11, expediently (in the first working configuration and the workpiece supporting position) the support side of the second rest 12 lies at the same height as the workpiece rest 103 of the electric vehicle 101. By way of this, it is possible to support a workpiece 200 (which in particular has a plane lower side) which lies on the workpiece rest 103 in a two-dimensional manner, additionally by the support side of the second rest 12.

Preferably (in the first working configuration and the workpiece support position) the distance from the support side of the second rest 12 to the lowest point of the table leg arrangement 13.2 (or to the stand surface 80) is equal to the distance from the rest plane of the workpiece rest 103 to the deepest point of the table leg arrangement 13.2 (or to the stand surface 80), in a state in which the electric tool 101 (with its lower side) is on the first rest 11 (and the workpiece rest 103 is aligned upwards away from the first rest 11).

The machining unit 100 in particular can be operated with a method, concerning which the portable work table 1 is firstly brought from the transport configuration into the first working configuration, the electric tool 101 (with its lower side) is then placed upon the first rest 11, the second rest 12 is then brought from the first rest position 12.1 into the second rest position 12.1 (in particular without moving the electric tool 101), a workpiece 200 is then placed upon the workpiece rest 103 in a two-dimensional manner, so that the workpiece 200 is additionally supported by the support side of the second rest 12, and the workpiece 200 is then machined with the tool (in particular the saw blade 102) of the electric tool 101, for example by way of the tool 200 being pushed onto the workpiece.

FIG. 10 shows an alternative embodiment of a portable work table 1 according to the invention with a separately formed transport vehicle 170. In the represented embodiment, the second rest is situated in the second rest position 12.2, in order to support a workpiece support for a workpiece 200 which is to be machined with a semi-stationary electric tool 101.

Basically, this embodiment has the same features as the previously described embodiment, so that it is only the differences which are dealt with here.

The alternative embodiment comprises a carrier structure 13 with a table leg arrangement 13.2 which only comprises a pair of table legs, in particular only one table leg unit. The one table leg unit by way of example is arranged at a first end of the carrier structure 13 in the longitudinal direction LR. By way of example, the second rest 12 is arranged at the first end of the carrier structure 13. As a further example, the rest 12 can be arranged distanced to the first end, for example distanced by between 20 centimetres and 50 centimetres.

In the first working position 21, the portable work table 1 is supported at the first end by the table leg unit and is supported at the end which is opposite in the longitudinal direction LR by the transport vehicle 170 and/or is coupled onto the transport vehicle 170.

The transport vehicle 170 comprises a frame 172, wheels 175 which are rotatably mounted on the frame 172 and a transport vehicle handle 174. The wheels 175 and the transport vehicle handle 174 are preferably arranged on the rear side 170.2 of the transport vehicle 170. The frame 172 further comprises a coupling location for coupling to the portable work table 1, in particular to the carrier structure 12.

A preferred embodiment envisages the transport vehicle 170 comprising a transport vehicle rest 171 which preferably forms an extension of the rest 10, in particular of the first rest 11 when the portable work table 1 is coupled to the transport vehicle 170.

The coupling location by way of example is arranged on the peripheral side of the transport vehicle rest 171. The coupling location comprises a coupling section which is arranged on the rear side 170.2, a coupling section which is arranged on the front side 170.1 which lies opposite the rear side 170.2 and/or a coupling section which is arranged on at least one of the sides 170.3 (between the rear side 170.2 and the front side 170.1), for coupling to the portable work table 1 and/or to the support structure 13. In FIG. 10, the carrier structure 13 is coupled to the coupling section which is arranged on the side 170.3.

In the shown example, the transport vehicle 170 comprises a transport vehicle placement surface 173 for receiving the transport box 150. The transport vehicle placement surface 173 in a purely optional manner can comprise a coupling receiver for receiving the coupling means 151 of the transport box 150.

In the transport configuration, the portable work table 1 is arranged vertically on the rear side 170.2 of the transport vehicle 170.

1-23. (canceled)

24. A portable work table comprising:
a carrier structure with a table leg arrangement with which the portable work table can be placed on a stand surface,
a rest which extends along a longitudinal direction and a width direction, wherein the rest comprises a first rest which is fixed to the carrier structure;
wherein the carrier structure can be brought into a first working configuration for use of the portable work table as a table,
wherein the portable work table can be brought into a transport configuration in which the portable work table can be manually brought into a tilt position and be moved relative to the stand surface, for the transport of the portable work table,
wherein the portable work table comprises a second rest which can be selectively brought into a first rest position or into a second rest position.

25. The portable work table according to claim 24, wherein the carrier structure can be brought into a second working configuration for the use of the portable work table as a base surface at a height close to the ground.

26. The portable work table according to claim 24, wherein the carrier structure further comprises a stand foot arrangement and/or
the portable work table comprises wheels which are arranged on the carrier structure and/or a handle for transporting the portable work table.

27. The portable work table according to claim 26, wherein the stand foot arrangement and/or the handle in the longitudinal direction is/are arranged on one side of the carrier structure and/or of the rest, and
the wheels in the longitudinal direction are arranged on the other side of the carrier structure and/or of the rest.

28. The portable work table according to claim 26, wherein the portable work table in the first working configuration can be placed with the table leg arrangement on the stand surface and the first rest can be aligned parallel to the stand surface, and/or
the portable work table in the second working configuration can be placed with the stand foot arrangement and/or the wheels on the stand surface and the first rest can be aligned parallel to the stand surface, and/or
in the transport configuration, the first rest is aligned essentially perpendicularly to the second rest and the portable work table is at least partly supported by the wheels.

29. The portable work table according to claim 24, wherein the portable work table can be brought into the transport configuration by way of the table leg arrangement being received in a table leg receiving volume below the rest, the second rest being brought into the second rest position and the portable work table being brought into an essentially vertical position.

30. The portable work table according to claim 29, wherein the table leg receiving volume is limited by the stand foot arrangement and/or the wheels.

31. The portable work table according to claim 30, wherein the carrier structure further comprises table leg receivers and a rest carrier, wherein the table leg arrangement is connected onto the rest carrier by way of the table leg receivers and/or the table leg arrangement is mounted on the table leg receivers in a manner such that the table leg arrangement can be brought from a working configuration position into a transport configuration position.

32. The portable work table according to claim 24, wherein the second rest can be brought from a first rest position into the second rest position by way of a translatory movement.

33. The portable work table according to claim 24, wherein the portable work table in the transport configuration forms a sack barrow with a ledge and/or
the portable work table in the first working configuration or a second working configuration forms a sub-frame for a semi-stationary electrical tool.

34. The portable work table according to claim 33, wherein the portable work table in the transport configuration forms a sack barrow with a ledge and the second rest in the transport configuration of the portable work table forms a ledge of the sack barrow, wherein the ledge with its upper side forms a placement surface for receiving a transport box.

35. The portable work table according to claim 34, wherein the placement surface comprises coupling receivers for receiving coupling means of the transport box.

36. The portable work table according to claim 24, wherein a hole structure is formed on the side of the rest, said side facing away from the carrier structure.

37. The portable work table according to claim 36, wherein the hole structure is designed to form a coupling interface for a semi-stationary electric tool.

38. A machining unit comprising the portable work table according to claim 24 and a semi-stationary electric tool, wherein the portable work table in the first working configuration or a second working configuration forms a sub-frame for the semi-stationary electrical tool,
wherein the electrical tool comprises at least one workpiece rest and a saw blade for the cutting machining of a workpiece which can be placed on the workpiece rest.

39. The machining unit according to claim 38, wherein the workpiece rest and the second rest are arranged to one another such that a side of the second rest and the workpiece rest have the same distance to a rest surface which is formed by the first rest.

40. The machining unit according to claim 39, wherein the side of the second rest faces away from the carrier structure.

41. The machining unit according to claim 38, wherein a plane workpiece which is placed onto the workpiece rest in a two-dimensional manner is also supported or supportable by the second rest.

42. The machining unit according to claim 41, wherein the plane workpiece placed onto the workpiece rest in the two-dimensional manner is supported or supportable by a side of the second rest which side is facing away from the carrier structure.

43. A method for operating the portable work table according to claim 24, comprising the step: bringing the second rest into a first rest position or into a second rest position.
